(19) United States
(12) Patent Application Publication
(10) Pub. No.: US 2006/0099357 A1
(43) Pub. Date: May 11, 2006

(54) Connecting and deflection element for pull strips in a pneumatic component

(76) Inventor: Mauro Pedretti, Biasca (CH)

Correspondence Address: JENKENS & GILCHRIST, PC, 1445 ROSS AVENUE, SUITE 3200, DALLAS, TX, 75202, US

(21) Appl. No.: 10/518,112

(22) PCT Filed: Mar. 31, 2003
(86) PCT No.: PCT/CH03/00208

§ 371 Date: Dec. 19, 2005

(30) Foreign Application Priority Data
Jun. 24, 2002 (CH) 1087/02

(51) Int. Cl. B31B 45/00

(52) U.S. Cl. 428/34.1

(57) ABSTRACT

Connecting and deflecting element for pneumatic structural elements, comprising a hollow body (1) with two caps (5), and also comprising a compression member (2) between two joint elements (3) on which tension members (4, 11) are fastened. The tension members (4, 11) run around the hollow body (1) once in opposite helical directions and thus cross over at a crossover location (7) on a lateral line (6) located opposite the compression member (2). The connecting and deflecting element according to the invention is fitted at the crossover location (7). It comprises a base plate (8) which has a milled relief (9). The tension members (4, 11) are positioned in this milled relief such that they themselves no longer cross over, but the point of intersection of the lines of action of the tensile forces, illustrated by chain-dotted lines (10), essentially still coincides with the crossover location (7). For a cover, four threads (13) are provided in the base plate (8).

The present invention relates to a connecting and deflecting element for tension members in a pneumatic structural element according to the preamble of Patent Claim 1.

In the case of pneumatic structural elements, for example according to WO 01/73245, the tensile loads which occur are transmitted to the pneumatic structural element from a joint element by tension members. At least two tension members are to be provided here, these, starting from the two joint elements of the pneumatic structural element, being positioned in opposite helical directions around the pneumatic structural element and being pulled tight. In the case of two tension members, these cross one another at one location; if, however, four tension members are provided, then, depending on the configuration of the wraparound angles and the number of joints provided, at least three crossover locations are possible.

The positions of the abovementioned crossover locations are mathematically easy to determine. Technical compliance with the mathematical prediction, however, depends, not least, on the care taken in the manual work carried out when constructing and setting up such a pneumatic structural element. In addition, in particular when the tension members are configured as steel cables, the crossover locations are the cause of defects in the form of the outer skin of the pneumatic structural element.

The object of the present invention is to provide a connecting and deflecting element of the abovementioned type which makes it possible to overcome the cited disadvantages and which, moreover, can be produced cost-effectively as a mass-produced item.

The solution to the set object is represented, in respect of its fundamental features, in the characterizing part of Patent Claim 1 and, in respect of further advantageous embodiments, in the subsequent patent claims.

The subject-matter of the invention with a number of exemplary embodiments and variants thereof will be explained in more detail with reference to the attached drawing, in which:

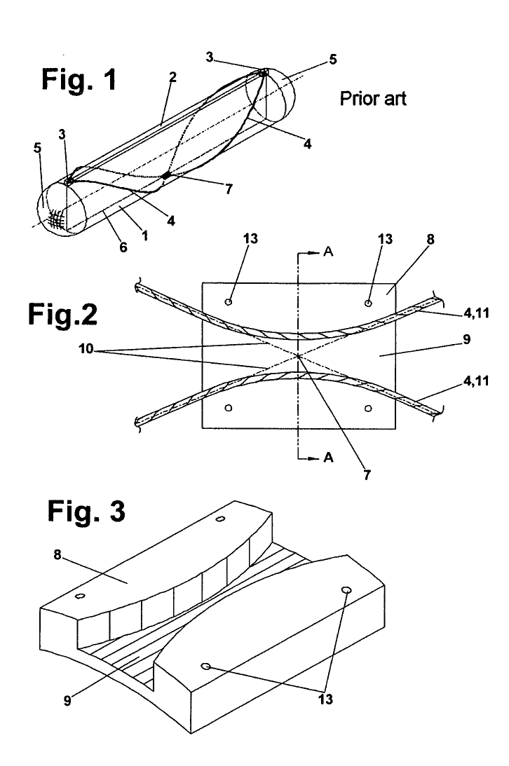

FIG. 1 shows a pneumatic structural element according to the prior art,

FIG. 2 shows a first exemplary embodiment of a connecting and deflecting element,

FIG. 3 shows an isometric illustration of the first exemplary embodiment of a connecting and deflecting element,

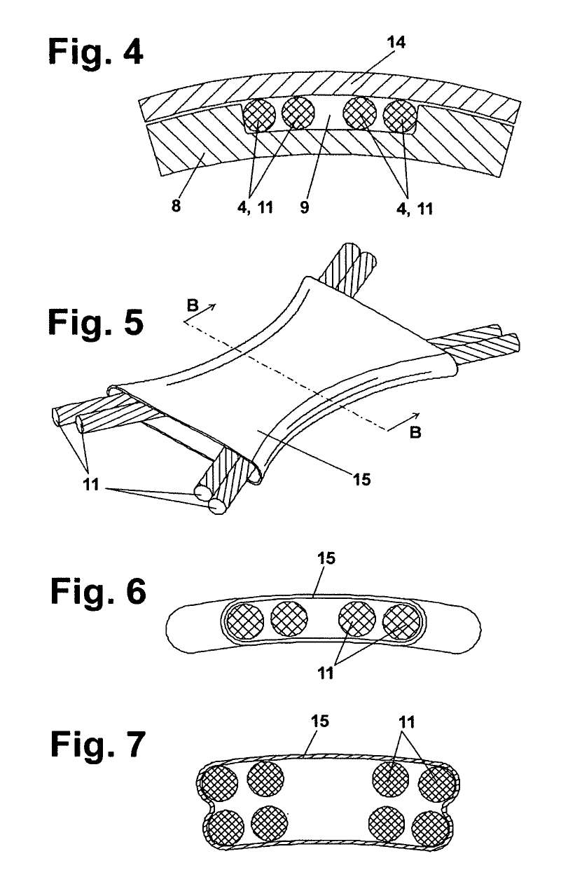

FIG. 4 shows a cross section of the first exemplary embodiment,

FIG. 5 shows an isometric illustration of a second exemplary embodiment of a connecting and deflecting element,

FIG. 6 shows a cross section of the second exemplary embodiment,

FIG. 7 shows a cross section of a variant of the second exemplary embodiment,

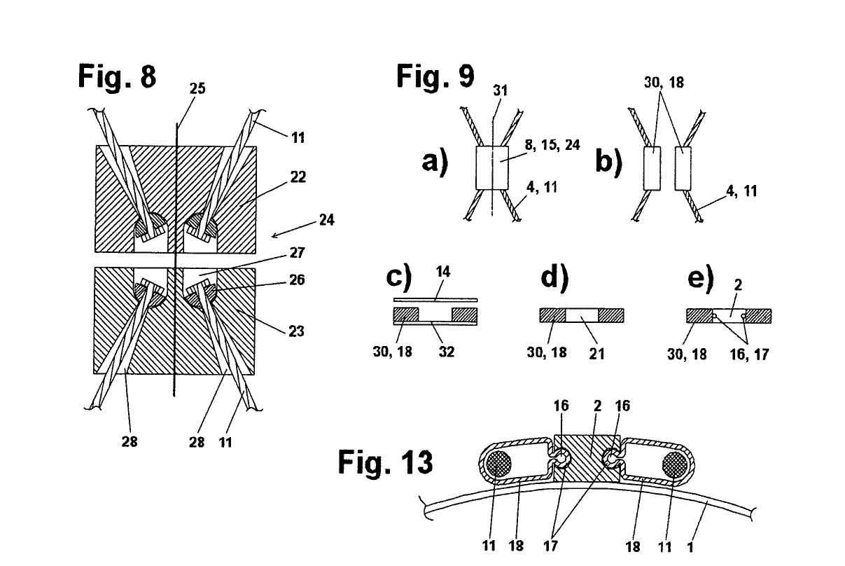

FIG. 8 shows a third exemplary embodiment,

FIG. 9 shows a scheme for producing variants of the three exemplary embodiments,

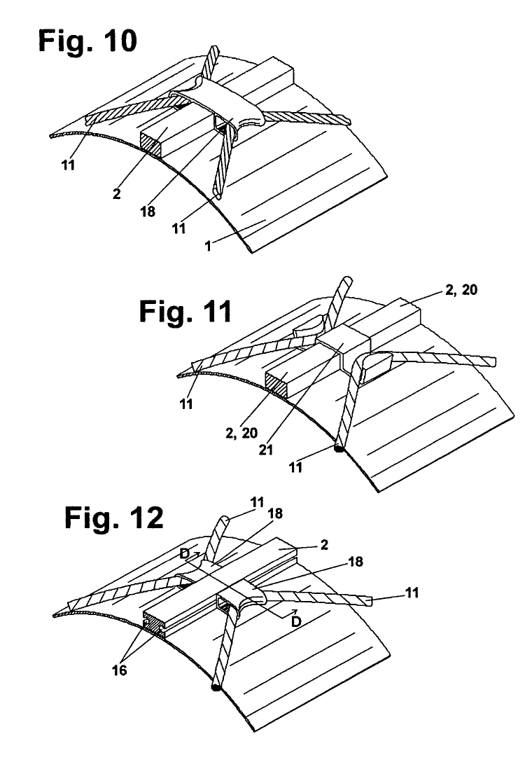

FIG. 10 shows an isometric illustration of a first variant of the second exemplary embodiment,

FIG. 11 shows an isometric illustration of a variant of the first exemplary embodiment,

FIG. 12 shows an isometric illustration of a second variant of the second exemplary embodiment, and

FIG. 13 shows a cross section of the second variant of the second exemplary embodiment.

FIG. 1 is an isometric illustration of a pneumatic structural element according to the prior art. It is constructed from an essentially cylindrical gas-tight hollow body 1 with two caps 5. A compression member 2 is clamped in between two joint elements 3. Also fastened on said compression member are two tension members 4, which are guided in opposite helical directions around the hollow body 1 and butt tightly against the same. The tension members 4 cross over one another on a lateral line 6, which runs opposite the compression member 2, at a crossover location 7 halfway along the cylindrical hollow body 1.

FIGS. 2 and 3 illustrate a first exemplary embodiment of a connecting and deflecting element according to the invention; FIG. 2 shows a plan view and FIG. 3 shows an isometric illustration. A plate 8, which is basically curved such that it butts smoothly against a hollow body 1 with a certain diameter, has a milled relief 9. Two tension members 4 in the form of cables 11 are positioned in the milled relief 9 and abut tangentially there without buckling. Two chain-dotted lines 10 indicate the lines of action of the cables 11. The lines of action 10 intersect one another at the crossover location 7 and indicate the course taken by the tensile forces running through the cables 11. The cables 11 themselves no longer cross over.

Four threads 13 are provided for a cover (not illustrated), which may be screwed, as a variant, onto the connecting and deflecting element.

In the cross section AA according to FIG. 4, four cables 11 are provided, in each case two cables located one beside the other form a tension member 4. A cover 14 is provided here in order to force the cables 11 to be guided one beside the other. The cover 14 may be designed such that it clamps the cables 11 simultaneously or else is a carrier of a clamping device—which is known but is not illustrated here.

Instead of being produced by milling, the completed plate 8—including the shaping element referred to as the milled relief 9—may be produced by stamping, drop-forging, extrusion or a similar, that is to say generally by a non-cutting, shaping method, which makes it possible to reduce the piece costs to a considerable extent.

FIGS. 5 and 6 are illustrations of a second exemplary embodiment of the connecting and deflecting element; FIG. 5 is an isometric illustration and FIG. 6 is a section BB. This connecting and deflecting element is configured as a hollow body 15 with a curvature which matches the pneumatic structural element of the selected size. The clear height of the hollow body 15, this being provided transversely to the cables 11, is dimensioned such that it corresponds to the diameter of the cables 11 such that these can be drawn in without being clamped. The cables 11 can be subsequently clamped in place by deformation of the flat hollow body 15 or by wedging.

A variant of the second exemplary embodiment according to FIG. 7, illustrated in a section analogous to FIG. 6, is provided for accommodating four or more cables 11. Either a tension member 4 then likewise comprises a plurality of cables 11 or it is necessary to uncross crossovers of more than two tension members 4.

The hollow bodies 15 according to FIGS. 5 to 7 may be shaped from tubular material, either by shaping on an individual basis and/or by extrusion, the latter, in particular, relating to FIGS. 12 and 13.

FIG. 8 shows a third exemplary embodiment of a connecting and deflecting element according to the invention. A connecting and deflecting element 24 constructed from two essentially identical parts 22, 23 is held together by a schematically illustrated screw connection 25. The entire axial projection of the tensile forces thus runs through the screw connection, which is of correspondingly tension-resistant configuration, for which means and materials are known per se. The cables 11 are fastened in anchors 26 with an outer contour in the form of spherical segments. These are located in correspondingly shaped sockets 27, with the result that the fastening locations of the cables 11 are not subjected to the action of any bending moments. Lead-outs 28 for the cables 11 are of correspondingly conical configuration. This makes it possible to allow for slight deviations from the desired geometry of the pneumatic structural element.

The connecting and deflecting element 24 may be configured, in a manner analogous to that of FIG. 4, as a curved plate or, in a manner analogous to that of FIG. 10, as part of the compression member 2. In the last-mentioned case, the screw connection 25 is purely for adjusting purposes or can also be dispensed with altogether.

Of course, it is also possible for the connecting and deflecting element 24 to be configured for more than four cables 11, irrespective of whether the cables are then to be arranged in one or more planes.

The connecting and deflecting element 24 is used, in particular, wherever numerous tension members are provided for a pneumatic structural element, for example in the case of a pneumatic structural element which is used as a column and subjected to axial loading. It may be advantageous here for the tension members 4 to be subdivided and for the parts to be joined together by connecting and deflecting elements 24. This facilitates, furthermore, a modular construction of pneumatic structural elements.

If a pneumatic structural element has two or more compression members 2, and if each compression member 2, as illustrated in FIG. 1, is assigned two tension members 4, this results in crossover locations 7 on or beneath the compression members. In order to avoid this, variants of the connecting and deflecting element 8, 15 and 24 are provided.

FIGS. 9a and b show, schematically, how a connecting and deflecting element 8, 15, 24 is divided along its centre line 31, parallel to the compression member, with the result that two functional halves 18, 30 are produced. These functional halves 18, 30 may then be joined together in various ways to form further variants of connecting and deflecting elements which avoid crossover locations 7 on a compression member 2.

In a first variant (FIG. 9c), the functional halves 18, 30 are fastened on a base plate 32 such that an interspace for the compression member 2 is produced. A cover 14 may likewise be fitted, as a result of which the compression member is enclosed by the connecting and deflecting element. Fitting the two functional halves 18, 30 only on the cover 14 and using no base plate 32 is likewise in accordance with the invention. A second variant (FIG. 9d) is based on the practice of introducing between the two functional halves 18, 30 a central part 21 which can be subjected to compressive loading, is fitted between pieces 20 of the compression member 2 and thus forms part of the compression member.

In a third variant (FIG. 9e), the functional halves 18, 30 are provided with comb-like protuberances 17 and the compression member 2 is provided with grooves 16 matching these protuberances 17. The functional halves 18, 30 can then be pushed into the grooves 16 and positioned. The operations of providing the protuberance 17 on the compression member 2 and the groove 16 on the functional halves 18, 30 are likewise in accordance with the invention.

FIGS. 10 to 12 show isometric illustrations of connecting and deflecting elements which correspond to the three variants in FIG. 9.

The connecting and deflecting element illustrated in FIG. 10 is positioned over the compression member 2, with the result that in each case one hollow body 18 butts laterally against the compression member 2. The hollow bodies 18 may be set up for accommodating in each case one or more cables 11.

The connecting and deflecting element in FIG. 11 is set up for accommodating in each case one or more cables 11 on each side of the compression member 2. It is further designed such that it can be inserted between two pieces 20 of the compression member 2; in other words, its central part 21 itself forms part of the compression member. The parts 20, 21 of the compression member 2 can be forced into alignment by mechanical means which are known per se.

The compression member 2 in FIG. 12 contains a groove 16 on each side, these grooves serving for accommodating protuberances 17 which are integrally formed on flat hollow bodies 18. The hollow bodies 18 may be configured such that they are suitable for one or more cables 11.

FIG. 13 is a sectional illustration DD of FIG. 12. The hollow body 18 with its protuberance 17 has been formed by virtue of the tubular component being shaped, and has been pushed into the groove 16 of the compression member 2.

1. Connecting and deflecting element for tension members (4) of pneumatic structural elements which comprise a cylindrical, gas-tight hollow body (1) with two caps (5), and also comprise a compression member (2) between two joint elements (3) and tension members (4) which are fastened at the ends of the compression member (2), characterized in that
means are provided in order to fit at least two tension members (4) such that a crossover location of these very tension members (4) is eliminated, but the lines of action of the tensile forces continue to intersect one another essentially at the same crossover location (7).

2. Connecting and deflecting element according to Patent claim 1, characterized in that it is formed such that the tension members (4) are located essentially one beside the other in one plane in the connecting and deflecting element.

3. Connecting and deflecting element according to Patent claim 1, characterized in that it is formed such that the tension members (4) are located essentially one above the other in a number of planes in the connecting and deflecting element.

4. Connecting and deflecting element according to Patent claim 1, characterized in that it is curved such that it butts flush against the cylindrical shape of the hollow body (1).

5. Connecting and deflecting element according to Patent claims 2, 3 and 4, characterized in that it is set up for tension members (4) which comprise at least two cables (11).

6. Connecting and deflecting element according to either of Patent claims 2 and 3 and Patent claim 4, characterized in that it is set up for tension members (4) which comprise at least two cables (11).

7. Connecting and deflecting element according to Patent claim 5 or 6, characterized in that it comprises a plate (8) which has a milled relief (9) for the tension members (4).

8. Connecting and deflecting element according to Patent claim 7, characterized in that it is produced by a non-cutting shaping method.

9. Connecting and deflecting element according to Patent claim 5 or 6, characterized in that it is configured as a hollow body (15).

10. Connecting and deflecting element according to Patent claim 5 or 6, characterized in that it is constructed from two essentially identical parts (22, 23), in which case
the parts (22, 23) each have at least two sockets (27) on one side,
the parts (22, 23) have, per socket (27), a conical lead-out (28) which runs from the socket (27) to the opposite side,
spherical-segment anchors, which fit flush in the sockets (27), are fastened at the ends of the tension members (4),
the tension members (4) are drawn through the lead-outs (28) from the sockets (27), and the anchors (26) abut with sliding action in the sockets (27), this counteracting the production of bending moments at the fastening locations of the tension members (4) under tensile loading,
the parts (22, 23) are joined together by a screw connection (25), which can be subjected to tensile loading, such that the sockets (27) rest on one another, and the parts (22, 23) form a connecting and deflecting element with one another.

11. Connecting and deflecting element according to one of Patent claims 7 to 10, characterized in that it is divided into two essentially identical functional halves (30) along the centre line (31) parallel to the compression member (2), each of the functional halves (30) deflecting at least one tension member (4) and being fitted on the compression member (2).

12. Connecting and deflecting element according to Patent claim 11, characterized in that the two functional halves (30) are fastened on a plate (8) so as to produce an interspace for the compression member (2), and a second plate (14) may be fastened as a cover, with the result that the compression member (2) is enclosed.

13. Connecting and deflecting element according to Patent claim 11, characterized in that introduced between the two functional halves (30) is a workpiece which can be subjected to compressive loading and can connect two pieces (20) of a compression member (2).

14. Connecting and deflecting element according to Patent claim 11, characterized in that one of the parts (2, 30) has a comb-like protuberance (17) and the other has a matching groove (16), and the functional halves (30) are thus fastened on the compression member (2) by the protuberance (17) being pushed into the groove (16) and positioned.

15. Connecting and deflecting element according to either of Patent claims 7 and 10, characterized in that it consists of a material which can be subjected to compressive loading and it can be fitted between two pieces (20) of a compression member (2).
